(19) United States
(12) Patent Application Publication
(10) Pub. No.: US 2026/0350205 A1
(43) Pub. Date: Nov. 5, 2026

(54) SYSTEMS AND METHODS FOR IMPLEMENTING ACCESS CONTROL POLICIES IN CONJUNCTION WITH SEMANTIC SEARCH ENGINES

(71) Applicant: Schlumberger Technology Corporation, Sugar Land, TX (US)

(72) Inventors: Vishal Lad, Pune (IN); Prashanth Pillai, Pune (IN); Kailash Pathak, Pune (IN); Akanksha Gaur, Pune (IN); Ritwik Singhai, Pune (IN)

(21) Appl. No.: 19/252,621

(22) Filed: Jun. 27, 2025

(30) Foreign Application Priority Data
Apr. 30, 2025 (IN) 202511041901

(51) Int. Cl. G06F 21/62; G06F 16/22; G06F 16/334

(52) U.S. Cl. CPC G06F 21/6227; G06F 16/2237; G06F 16/334; G06F 2221/2141

(57) ABSTRACT

Examples provide a system including a memory storing an access control enforcement service, and a processor. The processor is configured to receive a record and access control information associated with the record. The access control information indicates a set of user groups having access to at least a portion of the record. The processor generates at least one vector chunk embedding and stores the at least one vector chunk embedding in a vector database. The vector chunk embedding includes vector data of a segment of the record and a reference to the access control information associated with the record. Responsive to detecting a modification of the access control information associated with the record, the processor updates, in the vector database, the at least one vector chunk embedding associated with the record according to the modification.

### CROSS-REFERENCE TO RELATED APPLICATION

This application claims priority to and the benefit of Indian Application No. 202511041901, entitled “SYSTEMS AND METHODS FOR IMPLEMENTING ACCESS CONTROL POLICIES IN CONJUNCTION WITH SEMANTIC SEARCH ENGINES,” filed Apr. 30, 2025, which is hereby incorporated by reference in its entirety for all purposes.

### TECHNICAL FIELD

The present disclosure relates to search engines, and more specifically, systems and methods for implementing access control policies in conjunction with semantic search engines.

### BACKGROUND

Semantic search engines can work in conjunction with vector databases to generate natural language responses to queries. Vectors stored in a vector database can be used to represent values of data by encoding the features or attributes of the data as numerical values in an ordered list. Vectors may, for example, represent a variety of data types, such as words, sentences, documents, images, audio, graphs, tables, or the like. In some cases, vectors are stored in a vector database in the form of one or more vector embeddings. Vector embeddings are types of vectors that allow words or other semantic data to be represented as vectors in a continuous vector space. In that regard, vector embeddings capture semantic meanings and relationships between, for example, words based on their usage in the context of a larger text.

When a query is received by a semantic search engine, the query data is converted into vectors (e.g., semantic vector embeddings) using techniques like word embedding. The semantic search engine then measures the similarity between the query vector and the vectors in the vector database. The most similar vectors are retrieved (e.g., as similarity search results) and output to a large language model along with the query to generate a natural language response to the query.

In recent years, it has become increasingly more common for an organization to provide an organization-specific, or internal, semantic search engine that can be used by members of the organization to submit queries associated with business-related tasks. Upon receiving a query from a member of the organization, the internal semantic search engine can use private data stored in one or more organizational databases (e.g., vector databases and/or a record databases of the organization), as well as data external to the organization, to generate a response to the query. However, in many instances, data stored in a vector database and/or a record database of the organization is sensitive and not intended to be shared with all members of the organization. In that regard, organizations can implement access control policies that manage, or control, which data can be accessed by (e.g., directly or in the form of responses to queries submitted to the organization-specific semantic search engine) particular members and/or groups of members in the organization. For example, access control policies can be used to restrict access of one or more members to particular datasets according to one or more of organizational roles and/or teams to which members are assigned, security clearance levels of members, potential conflicts of interest involving members, and/or the like.

For instances in which an organization employs many members and/or stores large amounts of organizational data that varies in type and/or format, it can be difficult to implement access control policies in conjunction with an internal semantic search engine. Record collections are often used in databases to organize and store many different documents. In one conventional approach to implementing access control policies in conjunction with internal search engines, access control for members and/or member groups is enforced at the record collection level. In other words, the same access control policies must apply for all documents in a given record collection. For each user group having different levels of access to a set of documents, a different collection of those documents must be created. This conventional approach therefore requires the creation of many different collections for different user groups. Semantic searching across multiple record collections is inefficient, consumes large amounts of computing resources, and requires large amounts of data storage. For example, with this conventional approach, excessive computing resources are needed to push updates to the access control policies. Further, the use of many different record collections increases the risk of breaches in the access control policies for different users. For example, there is a greater risk that a user may be mistakenly granted access to a collection that they would not otherwise have the permission to view.

As the foregoing illustrates, what is needed are more effective techniques for implementing access control policies in conjunction with semantic search engines.

### SUMMARY

In one independent aspect, a computing system includes at least one memory storing an access control service, and at least one processor in communication with the at least one memory. The at least one processor is configured to execute the access control service to cause the at least one processor to receive a record and access control information associated with the record, wherein the access control information indicates a set of user groups having access to at least a portion of the record, generate, based on the record, at least one vector chunk embedding that includes vector data associated with a segment of the record and a reference to the access control information associated with the record, store the at least one vector chunk embedding in a vector database, detect a modification to the access control information associated with the record, and responsive to detecting the modification, update, in the vector database, the refence to the access control information in the at least one vector chunk embedding based on the modification.

In another independent aspect, a computing system includes at least one memory storing a semantic search service, and at least one processor in communication with the at least one memory. The at least one processor is configured to execute the semantic search service to cause the at least one processor to receive, from a record database, a record and access control information associated with the record, wherein the access control information indicates a set of users having access to at least a portion of the record, generate, based on the record, at least one vector chunk embedding that includes vector data associated with a segment of the record and a reference to the access control information associated with the record, store the at least one vector chunk embedding in a vector database, receive, from a computing device associated with a first user, a natural language search query, perform, based on the natural language search query and an access control policy associated with the first user, a filtered similarity search to retrieve, from the vector database, a filtered vector chunk embedding that includes access control information associated with the first user, and output the filtered vector chunk embedding to a large language model to generate a response to the natural language search query.

In another independent aspect, a computer-implemented method includes receiving, from a record database, a record and access control information associated with the record, wherein the access control information indicates a set of users having access to at least a portion of the record, generating at least one vector chunk embedding that includes vector data associated with a segment of the record and a reference to the access control information associated with the record, storing the at least one vector chunk embedding in a vector database, detecting a modification to the access control information associated with the record, and responsive to detecting the modification, updating, in the vector database, the reference to the access control information in the at least one vector chunk embedding based on the modification.

Other aspects will become apparent by consideration of the detailed description and accompanying drawings.

When compared to conventional approaches described herein in which record collections and/or datasets are recreated to implement access control policies, with the disclosed techniques, access control policies can be updated and applied to data stored in vector and/or record databases without recreating sets of the data. In that regard, at least one technical advantage of the disclosed techniques relative to conventional approaches is that, with the disclosed techniques, updates to access control policies can be more efficiently proliferated through a computing system and/or databases operating in conjunction with a semantic search engine. At least another technical advantage of the disclosed techniques relative to conventional approaches is that, with the disclosed techniques, data stored in the vector and/or record databases implemented in conjunction with the semantic search engine is more secure. In that regard, because the disclosed techniques allow for more efficient and easy updates to and/or enforcement of access control policies implemented in conjunction with the semantic search engine, the risk of inadvertently enabling a user to access data to which that user does not have permission to access is reduced.

### BRIEF DESCRIPTION OF THE DRAWINGS

FIG. 1 illustrates an example computing system, according to the present teachings.

FIG. 2 is a block diagram of a search engine server that may be implemented in conjunction with a computing system, according to the present teachings.

FIG. 3 is a block diagram of a client computing device that may be implemented in conjunction with a computing system, according to the present teachings.

FIG. 4 is a block diagram of an administrative computing device that may be implemented in conjunction with a computing system, according to the present teachings.

FIG. 5 is a block diagram of an access control server that may be implemented in conjunction with a computing system, according to the present teachings.

FIG. 6 is a block diagram of a record database server that may be implemented in conjunction with a computing system, according to the present teachings.

FIG. 7 is a block diagram of a vector database server that may be implemented in conjunction with a computing system, according to the present teachings.

FIG. 8A illustrates an example vector chunk embedding, according to the present teachings.

FIG. 8B illustrates another example vector chunk embedding, according to the present teachings.

FIG. 9 illustrates an example flow diagram of a process for storing vector chunk embeddings in a vector database, according to the present teachings.

FIG. 10 illustrates an example flow diagram of a process for modifying access control policies implemented in conjunction with a search engine, according to the present teachings.

FIG. 11 illustrates an example flow diagram of a process for performing a semantic search, according to the present teachings.

FIG. 12 illustrates an example flow diagram of a process for modifying access control policies implemented in conjunction with a search engine, according to the present teachings.

FIG. 13 illustrates a workflow that may be implemented by a computing system, according to the present teachings.

FIG. 14 illustrates an example flow diagram of method steps for implementing access control policies implemented in conjunction with a search engine, according to the present teachings.

FIG. 15 illustrates an example flow diagram of method steps for enforcing access control policies implemented in conjunction with a search engine, according to the present teachings.

FIG. 16 illustrates an example flow diagram of method steps for performing a search using a semantic search engine, according to the present teachings.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

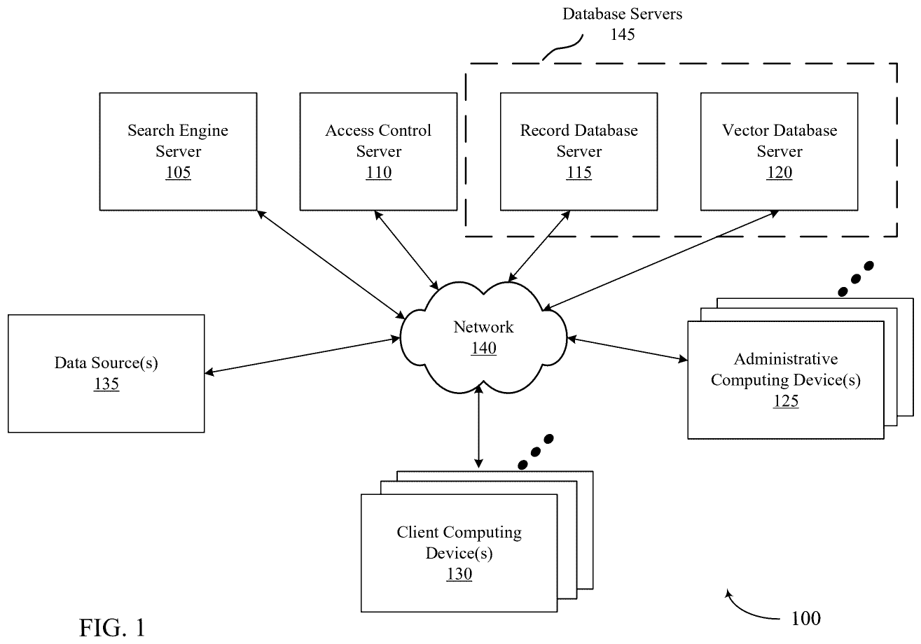

Referring now to FIG. 1, shown is an example computing system 100, according to the present teachings. As shown, the computing system 100 includes a search engine server 105, an access control server 110, a record database server 115, a vector database server 120, administrative computing devices 125, client computing devices 130, and a data source 135 (e.g., one or more data sources 135), each of which are connected via a communications network 140. In some examples, the record database server 115 and the vector database server 120 together form database server 145.

In the following description, administrative computing devices 125 may be referred to individually as an administrative computing device 125. Each administrative computing device 125 communicates with one or more of the search engine server 105, the access control server 110, the record database server 115, and/or the vector database server 120 via the network 140 to retrieve data from, or write data to, the access control server 110, the record database server 115, and/or the vector database server 120. For example, an administrative computing device 125 can control a writing of data from the data source 135 to the record database server 115 and/or the vector database server 120. In some examples, each administrative computing device 125 communicates with the access control server 110, the record database server 115, and/or the vector database server 120 via the search engine server 105 such that the search engine server 105 operates as an intermediary layer between administrative computing devices 125 and the access control server 110 and/or database servers 145.

In the following description, client computing devices 130 may be referred to individually as a client computing device 130. A client computing device 130 can communicate with the search engine server 105, via the network 140, to retrieve data from the record database server 115 and/or the vector database server 120. For example, the search engine server 105 can operate as an intermediary layer between client computing devices 130 and the access control server 110 and/or the database servers 145. In some examples, a computing device can operate as both a client computing device 130 and an administrative computing device 125.

Data stored in the record database server 115 can include, without limitation, textual data, graphical data, audio data, video data, tables, graphs, and other types of data. Vector embedding of the data stored in the record database server 115 can be stored in the vector database server 120. As will be described in more detail herein, the access control server 110 controls access to data stored in the record database server 115 and/or the vector database server 120. Although only a single access control server 110, a single record database server 115, and a single vector database server 120 are shown in FIG. 1, in some examples, multiple access control servers 110, multiple record database servers 115, and/or multiple vector database servers 120 may be implemented to store data and manage access to the data in the computing system 100. In some examples, the record database server 115 and the vector database server 120 can be implemented on the same server.

In some examples, the search engine server 105 is integrated within one or more other servers included in the computing system 100. In some examples, the search engine server 105 is implemented as a service, or application, running on one or more of the servers included in the computing system 100. Persons skilled in the art will understand that although specific functions are primarily described herein with respect to respective ones of the search engine server 105, the access control server 110, the record database server 115, or the vector database server 120, in some examples, one or more functions can be performed by other components of the computing system 100.

Data received from a data source 135 can be stored in the record database server 115 and vectorized for further storage in the vector database server 120. For example, the record database server 115 stores a copy, or record, of the data received from the data source 135 and the vector database server 120 stores a vector embedding associated with the record of the data received from the data source 135. The access control server 110 controls access to data, or records, received from the data sources 135. In some examples, the record database server 115 and/or the vector database server 120 can also store access control policies associated with the data received from the data source 135.

The search engine server 105 can operate as a search engine. For example, the search engine server 105 can receive from a client computing device 130, a search query and generate a response to the received search query. In some examples, the search engine server 105 operates as a semantic search engine. In such examples, search queries received from client computing devices 130 are natural language search queries and the responses generated by the search engine server 105 are natural language responses. In some examples, the search engine server 105 generates a response to the search query by retrieving data from the vector database server 120 (e.g., by performing a semantic search) in accordance with the access control policies defined using the access control server 110. That is, the search engine server 105 generates responses to received search queries without violating any access control policies defined and/or enforced by the access control server 110.

For example, different users of the client computing devices 130 may be granted access to different records that are stored in the record database server 115 and/or the vector database server 120. These access control policies may be based on user roles, organization departments, tenure, assigned projects, security clearance, or the like. When generating a response to a search query received from a particular user, the search engine server 105 generates a response that does not include and/or consider data that the particular user submitting the response query is restricted from accessing.

As used herein, access control policies refer to the policies that manage which sets of data users and/or groups of users of the computing system 100 may access or otherwise interact with. For example, access control policies can include mappings of individual users to user groups. Moreover, access control policies can also include mappings of individual records to user groups. A mapping of individual record to a user group can, for example, indicate whether that user group is permitted to access the data included in that individual record. Information included as part of the access control policies of the computing system 100 is referred to herein as access control information. Hereinafter, the mappings and/or user groups defined by the access control policies may be referred to as access control information. Access control information can be stored in various components of the computing system 100. For example, the access control server 110 stores different access control information or the same access control information as the record database server 115. In some examples, the access control server 110 stores access control information that maps users to user groups, and the record database server 115 stores access control information that maps records to user groups. As referred to herein, updating, modifying, and/or otherwise configuring an access control policy can include one or more of updating the access control policy information associated with an access control policy, updating and/or creating a new mapping between user groups and particular data records stored in the computing system 100, adding and/or removing users from a user group, defining which users and/or user groups can access a particular data record, and/or one or more other actions associated managing user access to data.

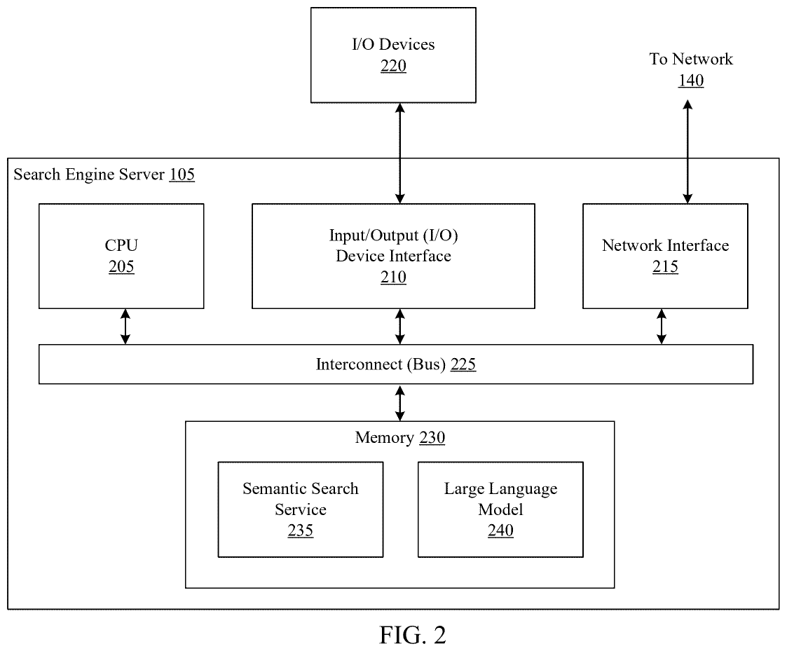

FIG. 2 is a block diagram of a search engine server 105 that may be implemented in conjunction with the computing system 100 of FIG. 1, according to the present teachings. As described herein, the search engine server 105 receives search queries (e.g., natural language search queries) from the client computing devices 130 and generates responses (e.g., natural language responses) to the search queries based in part on select data stored in the record database server 115 and/or the vector database server 120. In some examples, one or more of the functions performed by the search engine server 105 can be implemented by a different server in the computing system 100 (e.g., access control server 110, the record database server 115, and/or the vector database server 120).

As shown, the search engine server 105 includes, without limitation, a central processing unit (CPU) 205, an input/output (I/O) devices interface 210, a network interface 215, I/O devices 220, an interconnect 225, and a system memory 230. The CPU 205 is configured to retrieve and execute programming instructions, such as a semantic search service 235 and a large language model (LLM) 240, stored in the system memory 230. Similarly, the CPU 205 is configured to store application data (e.g., software libraries) and retrieve application data from the system memory 230. The interconnect 225 is configured to facilitate transmission of data, such as programming instructions and application data, between the CPU 205, I/O devices interface 210, the network interface 215, and the system memory 230. The I/O devices interface 210 is configured to receive input data from I/O devices 220 and transmit the input data to the CPU 205 via the interconnect 225. For example, I/O devices 220 may include one or more buttons, a keyboard, a mouse, and/or other input devices. The I/O devices interface 210 is further configured to receive output data from the CPU 205 via the interconnect 225 and transmit the output data to the I/O devices 220.

The system memory 230 may be provided in the form of a single memory unit or multiple memory units and may be one or more articles of manufacture and/or machine components. The system memory 230 may include static memory, dynamic memory, or both in communication. In some examples, the system memory 230 may be one or more tangible storage mediums that can store data and executable instructions and may be non-transitory during the time instructions are stored therein. The system memory 230 includes a semantic search service 235 (e.g., in the form of processor-executable software code) and an LLM 240. Using the LLM 240, the semantic search service 235 can process natural language queries received from the client computing devices 130 and generate responses to the queries based on vector data stored in the vector database server 120 and/or records stored in the record database server 115.

In some examples, the semantic search service 235 can perform a vector similarity search with respect to vector data stored in the vector database server 120. In some examples, the semantic search service 235 can receive user credentials associated with the user of a client computing device 130 and retrieve, from the access control server 110, the access control policies associated with that user of the client computing device 130 based on the user credentials. In some examples, the semantic search service 235 performs a vector similarity search based on a natural language query received from a client computing device 130 and the access control policies received from the access control server 110. In accordance with the present teachings, a vector similarity search returns results comprising vector embeddings that adhere to the access control policies associated with the user of the client computing device 130. The semantic search service 235 generates, using the LLM 240, a natural language response to the query based on the search results received from the vector database server 120, and transmits the natural language response to the client computing device 130. In some examples, the semantic search service 235 also transmits to the client computing device 130 the original record (e.g., stored in the record database server 115) that is associated with the results of the vector similarity search.

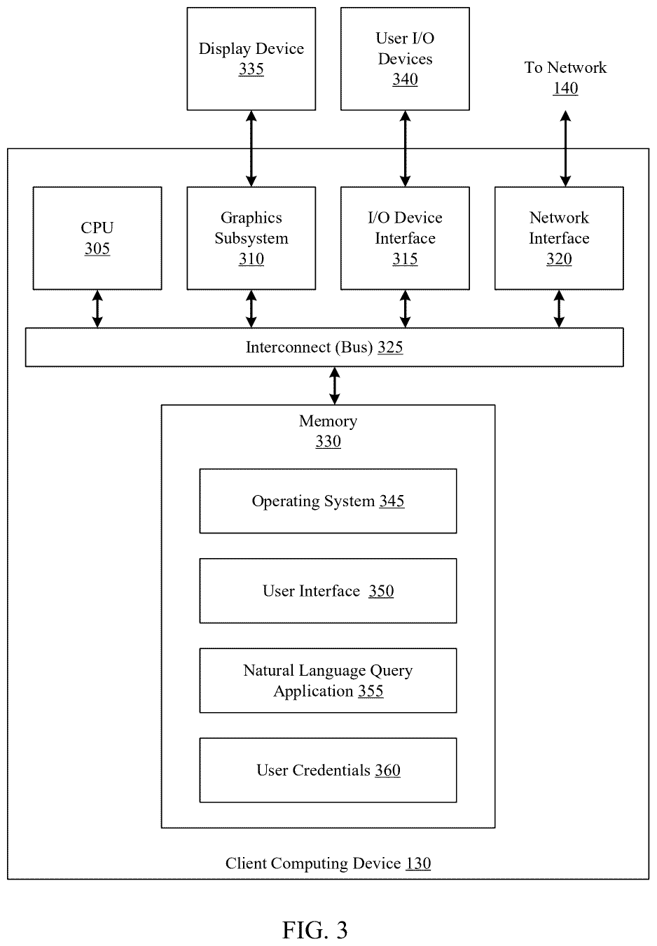

FIG. 3 is a block diagram of a client computing device 130 that may be implemented in conjunction with the computing system 100, according to the present teachings. As shown, the client computing device 130 may include, without limitation, a CPU 305, a graphics subsystem 310, an I/O device interface 315, a network interface 320, an interconnect 325, and a memory 330.

In some examples, the CPU 305 is configured to retrieve and execute programming instructions stored in the memory 330. Similarly, the CPU 305 is configured to store and retrieve application data (e.g., software libraries) residing in the memory 330. The interconnect 325 is configured to facilitate transmission of data, such as programming instructions and application data, between the CPU 305, graphics subsystem 310, I/O devices interface 315, network interface 320, and memory 330.

In some examples, the graphics subsystem 310 is configured to generate visual data and transmit the visual data to display device 335. In some examples, the graphics subsystem 310 may be integrated into an integrated circuit, along with the CPU 305. The display device 335 may comprise any technically feasible means for generating visual data for display. For example, the display device 335 may be fabricated using liquid crystal display (LCD) technology, cathode-ray technology, and light-emitting diode (LED) display technology. An input/output (I/O) device interface 315 is configured to receive input data from user I/O devices 340 and transmit the input data to the CPU 305 via the interconnect 325. For example, user I/O devices 340 may comprise one or more buttons, a keyboard, and a mouse or other pointing device. The I/O device interface 315 may also include an audio output unit configured to generate an electrical audio output signal. The client computing device 130 may be any type of computing device, such as a desktop computer, laptop, mobile phone, tablet, database, personal digital assistant (PDA), tablet, personal computer, or other electronic device.

The network interface 320 is configured to transmit and receive packets of data via the network 140. For example, the network interface 320 is used to transmit queries (e.g., natural language queries) to the search engine server 105 and receive response from the search engine server 105. The network interface 320 is coupled to the CPU 305 via the interconnect 325.

The memory 330 may be provided in the form of a single memory unit or multiple memory units and may be one or more articles of manufacture and/or machine components. The memory 330 may include static memory, dynamic memory, or both in communication. In some examples, the memory 330 may be one or more tangible storage mediums that can store data and executable instructions and may be non-transitory during the time instructions are stored therein. In some embodiments, the memory 330 includes programming instructions and application data that comprise an operating system 345, a user interface 350, a natural language query application 355, and user credentials 360 associated with a user of the client computing device 130.

The operating system 345 performs system management functions such as managing hardware devices including the network interface 320, I/O device interface 315, and graphics subsystem 310. The operating system 345 also provides process and memory management models for the user interface 350, the natural language query application 355, and the user credentials 360. The user interface 350, such as a window and object metaphor, provides a mechanism for user interaction with the client computing device 130. Persons skilled in the art will recognize the various operating systems and user interfaces that are well-known in the art and suitable for incorporation into the client computing device 130.

In some examples, the natural language query application 355 receives, via the I/O devices interface 315, user input including a natural language query, and transmits the natural language query to the search engine server 105. In some examples, the natural language query application also transmits, prior to or in conjunction with the natural language query, the user credentials 360 to the search engine server 105. In some examples, the natural language query application transmits the user credentials 360 to the semantic search service 235 during initiation of a client session with the search engine server 105 (e.g., responsive to a launching of the natural language query application 355).

The natural language query application 355 can receive a natural language response to the query from the search engine server 105, and can display the natural language response to the display device 335 (e.g., within a user interface 350). In some examples, the natural language query application 355 further receives one or more media files associated with the natural language response, and displays the media files or a link to the media files to the display device 335.

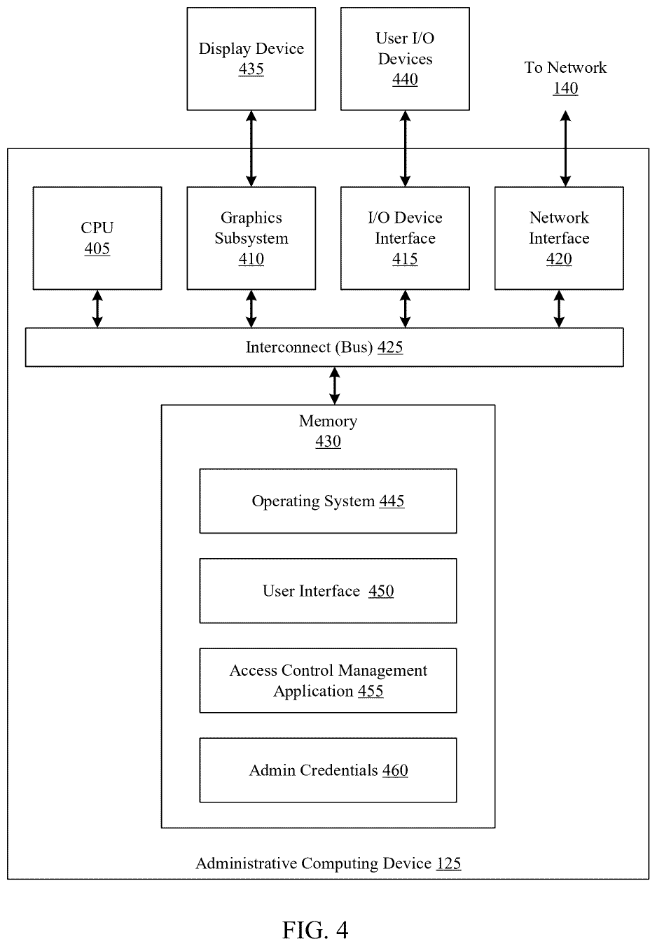

FIG. 4 is a block diagram of an administrative computing device 125 that may be implemented in conjunction with the computing system 100, according to the present teachings. As shown, the administrative computing device 125 may include, without limitation, a CPU 405, a graphics subsystem 410, an I/O device interface 415, a network interface 420, an interconnect 425, and a memory 430.

In some examples, the CPU 405 is configured to retrieve and execute programming instructions stored in the memory 430. Similarly, the CPU 405 is configured to store and retrieve application data (e.g., software libraries) residing in the memory 430. The interconnect 425 is configured to facilitate transmission of data, such as programming instructions and application data, between the CPU 405, graphics subsystem 410, I/O devices interface 415, network interface 420, and memory 430.

In some examples, the graphics subsystem 410 is configured to generate visual data and transmit the visual data to display device 435. In some examples, the graphics subsystem 410 may be integrated into an integrated circuit, along with the CPU 405. The display device 435 may comprise any technically feasible means for generating visual data for display. For example, the display device 435 may be fabricated using liquid crystal display (LCD) technology, cathode-ray technology, and light-emitting diode (LED) display technology. An input/output (I/O) device interface 415 is configured to receive input data from user I/O devices 440 and transmit the input data to the CPU 405 via the interconnect 425. For example, user I/O devices 440 may comprise one or more buttons, a keyboard, and a mouse or other pointing device. The I/O device interface 415 may also include an audio output unit configured to generate an electrical audio output signal. The administrative computing device 125 may be any type of computing device, such as a desktop computer, laptop, mobile phone, tablet, database, personal digital assistant (PDA), tablet, personal computer, or other electronic device.

The network interface 420 is configured to transmit and receive packets of data via the network 140. For example, the network interface 420 is used to transmit access control policies and/or updates to access control policies to the access control server 110. In some examples, the network interface 420 is further used to control the upload of data from the data source 135 to the record database server 115. The network interface 420 is coupled to the CPU 405 via the interconnect 425.

The memory 430 may be provided in the form of a single memory unit or multiple memory units and may be one or more articles of manufacture and/or machine components. The memory 430 may include static memory, dynamic memory, or both in communication. In some examples, the memory 430 may be one or more tangible storage mediums that can store data and executable instructions and may be non-transitory during the time instructions are stored therein. In some embodiments, the memory 430 includes programming instructions and application data that comprise an operating system 445, a user interface 450, an access control management application 455, and administrative credentials 460 associated with a user of the administrative computing device 125.

The operating system 445 performs system management functions such as managing hardware devices including the network interface 420, I/O device interface 415, and graphics subsystem 410. The operating system 445 also provides process and memory management models for the user interface 450, the access control management application 455, and the administrative credentials 460. The user interface 450, such as a window and object metaphor, provides a mechanism for user interaction with the administrative computing device 125. Persons skilled in the art will recognize the various operating systems and user interfaces that are well-known in the art and suitable for incorporation into the administrative computing device 125.

In operation, the access control management application 455 is used to establish and/or modify existing access control policies. As described herein, access control policies define which users and/or groups of users can access particular sets, or collections, of records stored in the record database server 115 and/or vector embedding stored in the vector database server 120.

In some examples, the access control management application 455 receives, via the I/O devices interface 415, a user input indicating a new record (e.g., received via the data source 135) to be stored in the record database server 115 and access control policies associated with the new record. The access control policies can indicate individual users and/or sets of user groups that are granted access to the record. For example, the computing system 100 may be associated with a plurality of system users that interface with the database servers 145 via one or more respective client computing devices 130. The plurality of system users may be organized into a plurality of user groups based on roles, departments, tenure, assigned projects, security clearance, and/or other criteria. In some examples, users can be included in more than one user group.

Table 1, below, provides an example of user groups defined by one or more access control policies of the computing system 100:

TABLE 1

| User | User Groups |
|---|---|
| User_A | [“Group_1”, “Group_2”] |
| User_B | [“Group_2”] |
| User_C | [“Group_3”] |
| User_D | [“Group_2”, “Group_3”] |
| User_E | [ ] |
| User_F | [“Group_1”, “Group_2”, “Group_3”] |

As shown in the example of Table 1, Group_1 includes User_A, User_B, and User_F. Group_2 includes User_A, User_B, User_D, and User_F. Group_3 includes User_C, User_D, and User_F. No groups include User_E.

Each record stored in the record database server 115, as well as the vectorization of the record stored in the vector database server 120, can be associated with one or more user groups using one or more access control policies. For example, one or more access control policies can be used to define which users and/or user groups are permitted to access particular record stored in the record database server 115 and/or the respective vector embeddings of the particular records stored in the vector database server 120.

In some examples, the administrative computing device 125 is used to create new and/or modify existing access control policies. For example, using the access control management application 455, a user with proper appropriate administrative credentials 460 can create new and/or modify existing access control policies. Modifying an access control policy with the access control management application 455 can include modifying which user and/or groups of user have access to a respective record, adding users to respective user groups, removing users from respective user groups, creating or deleting user groups, registering or unregistering users in the computing system 100, and/or combinations thereof. The access control management application 455 can also transmit newly created access control policies and/or push updates to existing access control policies to the access control server 110 and/or the record database server 115.

In some examples, the access control management application 455 can also request access control information included associated with the access control policies (e.g., user groups, registered users, record-specific access control mappings, etc.) from the access control server 110 and/or the record database server 115. In response to receiving the access control information, the access control management application 455 can display the requested data using the display device 435 (e.g., within a user interface 450).

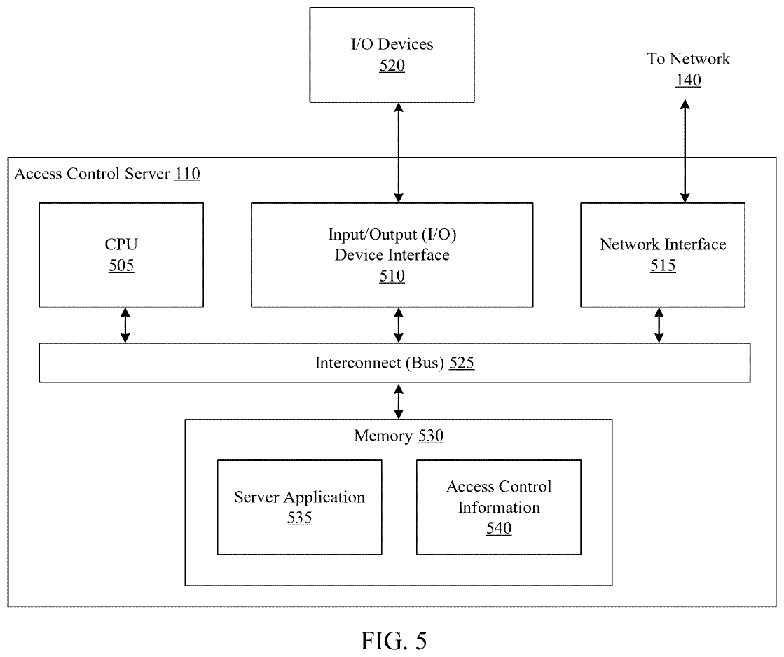

FIG. 5 is a block diagram of an access control server 110 that may be implemented in conjunction with the computing system 100, according to the present teachings. In some examples, the access control server 110 is integrated with one or more servers included in the database servers 145.

As shown, the access control server 110 includes, without limitation, a CPU 505, an input/output (I/O) devices interface 510, a network interface 515, I/O devices 520, an interconnect 525, and a system memory 530. The CPU 505 is configured to retrieve and execute programming instructions, such as a server application 535. Similarly, the CPU 505 is configured to store application data (e.g., software libraries) and retrieve application data from the system memory 530. The interconnect 525 is configured to facilitate transmission of data, such as programming instructions and application data, between the CPU 505, I/O devices interface 510, the network interface 515, and the system memory 530. The I/O devices interface 510 is configured to receive input data from I/O devices 520 and transmit the input data to the CPU 505 via the interconnect 525. For example, I/O devices 520 may include one or more buttons, a keyboard, a mouse, and/or other input devices. The I/O devices interface 510 is further configured to receive output data from the CPU 505 via the interconnect 525 and transmit the output data to the I/O devices 520.

The system memory 530 may be provided in the form of a single memory unit or multiple memory units and may be one or more articles of manufacture and/or machine components. The system memory 530 may include static memory, dynamic memory, or both in communication. In some examples, the system memory 530 may be one or more tangible storage mediums that can store data and executable instructions and may be non-transitory during the time instructions are stored therein. The system memory 530 includes a server application 535 that services requests from the administrative computing device 125 to create new access control policies, modify existing access control policies, and/or return access control information 540 stored in the memory 530 and associated with one or more access control policies. As described above, the access control information 540 stored in the access control server 110 is included as at least part of the access control policies of the computing system 100, and can include mappings of system users to one or more respective user groups. In some examples, the access control information 540 is stored as a remote file wrapper.

In some examples, the access control information 540 further includes mappings of the user groups to respective records stored in the record database server 115. However, in other examples, only the record database server 115 and/or the vector database server 120 store mappings of the user groups to respective records. In some examples, the server application 535 receives a request to modify or configure the mappings of user groups to one or more respective records. In some examples, the server application 535 propagates the modifications to the record database server 115 and/or the vector database server 120 by transmitting modification requests to the record database server 115 and/or the vector database server 120 via the network interface 515.

The server application 535 can also service requests from the search engine server 105 and/or the vector database server 120 to return the access control information 540 associated with specific users. For example, the server application 535 can receive a request from the search engine server 105 for the access control information associated with the user of the client computing device 130 from which a natural language query was received (e.g., received by the search engine server 105). The server application 535 can receive an indication of the identity of the user of the client computing device 130, and can output (e.g., via the network interface 515) an indication of the user groups in which the user of the client computing device 130 is a member. In some examples, the server application 535 receives the request for the access control information from the vector database server 120 in lieu of or in addition to the search engine server 105. In such examples, the server application 535 can output the requested access control information to the vector database server 120.

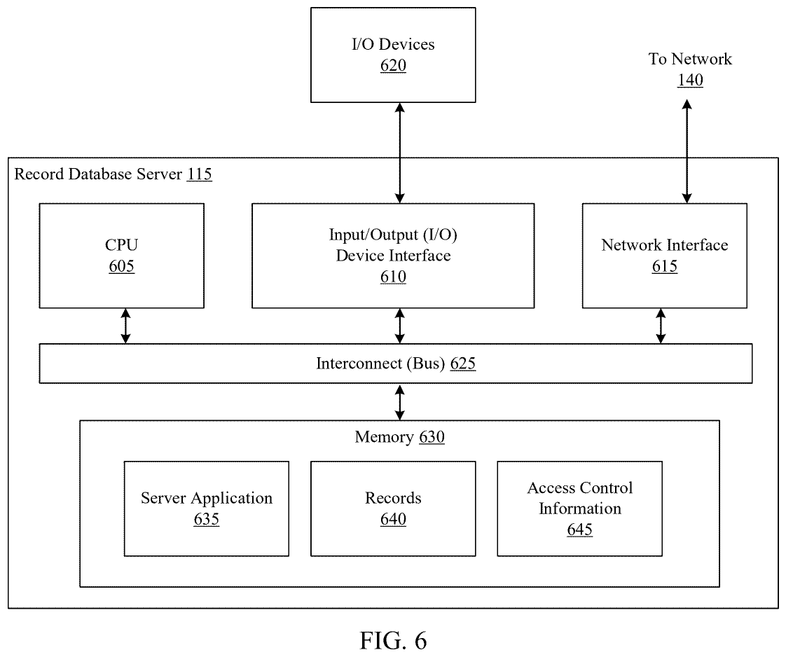

FIG. 6 is a block diagram of a record database server 115 that may be implemented in conjunction with the computing system 100, according to the present teachings. In some examples, the record database server 115 is integrated with one or more servers included in the database servers 145.

As shown, the record database server 115 includes, without limitation, a CPU 605, an input/output (I/O) devices interface 610, a network interface 615, I/O devices 620, an interconnect 625, and a system memory 630. The CPU 605 is configured to retrieve and execute programming instructions, such as a server application 635. Similarly, the CPU 605 is configured to store application data (e.g., software libraries) and retrieve application data from the system memory 630. The interconnect 625 is configured to facilitate transmission of data, such as programming instructions and application data, between the CPU 605, I/O devices interface 610, the network interface 615, and the system memory 630. The I/O devices interface 610 is configured to receive input data from I/O devices 620 and transmit the input data to the CPU 605 via the interconnect 625. For example, I/O devices 620 may include one or more buttons, a keyboard, a mouse, and/or other input devices. The I/O devices interface 610 is further configured to receive output data from the CPU 605 via the interconnect 625 and transmit the output data to the I/O devices 620.

The system memory 630 may be provided in the form of a single memory unit or multiple memory units and may be one or more articles of manufacture and/or machine components. The system memory 630 may include static memory, dynamic memory, or both in communication. In some examples, the system memory 630 may be one or more tangible storage mediums that can store data and executable instructions and may be non-transitory during the time instructions are stored therein. The system memory 630 includes a server application 635 that services requests from the administrative computing device 125 for storing one or more records 640 received from the data source 135. The server application 635 further services requests from the administrative computing device 125 for storing and/or modifying access control information 645 associated with the respective records 640. For example, the server application 635 stores and/or modifies access control information associated with records in accordance with one or more access control policies. As described above, the access control information 645 stored in the record database server 115 is included as at least part of the access control policies of the computing system 100, and can include mappings of records 640 to one or more user groups.

The server application 635 can receive, via the network interface 615, one or more media files from the data source 135 and process the media files to generate the records 640. The data source 135 can be any suitable data source for the records 640. In some examples, the data source 135 includes an open subsurface data universe (OSDU) platform, and the data or media files received from the OSDU platform includes oilfield services and technology (OST) data. The data may include text data, image data, audio data, video data, seismic data, well logging data, wellbore production data, reservoir data, geospatial data, 3D modeling data, or combinations thereof. In generating one or more storable records for the received data, the server application 635 can process the data to generate a transcript of the record (e.g., an audio or video transcription), to perform an optical character recognition (OCR) for the record, to identify one or more classifications for the record (e.g., using a machine learning model or other record classification mechanism), and/or perform other processing techniques.

In some examples, the server application 635 also receives (e.g., from an administrative computing device 125 via the network interface 615) requests to configure or modify the access control information 645 for one or more of the records 640. As described above, the access control information 645 stored in the record database server 115 maps individual records or sets of records to sets of user groups having access to the individual records or sets of records. For example, each record can have a corresponding record identifier (ID). In some examples, the record ID of each record is common to, or derivative from, a media file name from which the server application 635 generated the record. In other examples, the respective record IDs are distinct from the media file names from which the respective records originate.

Table 2, below, provides an example of access control information 645 of sets of user groups to respective records 640:

TABLE 2

| Record ID | Access Control Groups |
|---|---|
| Record_1 | [“Group_1”, “Group_3”] |
| Record_2 | [“Group_1”, “Group_2”, “Group_3”] |
| Record_3 | [ ] |
| Record_4 | [“Group_3”] |

As shown in the example of Table 2, Record_1 is mapped to the set of user groups including Group_1 and Group_3. Record_2 is mapped to the set of user groups including Group_1, Group_2, and Group_3. Record_3 is mapped to the empty set of user groups (e.g., no user groups). Record_4 is mapped to the set of user groups including Group_3. Following the examples of Table 1 and Table 2, User_A has access to Record_1 and Record_2. User_B has access to Record_2. User_C has access to Record_1, Record_2, and Record_4. User_D has access to Record_1, Record_2, and Record_4. User_E has access to no records. User_F has access to Record_1, Record_2, and Record_4. As described, when a record is mapped to a respective user group, users in that user group are permitted to access the data included in the record.

In some instances, the server application 635 applies a default access control mapping to one or more records received from the data source 135. For example, the server application 635 can automatically apply the default mapping to a record if no access control mapping for the record is received from the administrative computing device 125. In some examples, the default access control mapping is the empty set of user groups. In some examples, the default access control mapping is the set of all user groups.

In some examples, responsive to storing a new record in the record database server 115, the server application 635 transmits the record and the associated access control information to the vector database server 120 via the network interface 615. In some examples, the server application 635 modifies the access control information associated with an existing record (e.g., a record that is already vectorized in the vector database server 120). In such examples, responsive to modifying the access control information of the existing record, the server application 635 can transmit, to the vector database server 120, a notification of an access control change event. The server application 635 can output the notification using, for example, a queue service between the record database server 115 and the vector database server 120.

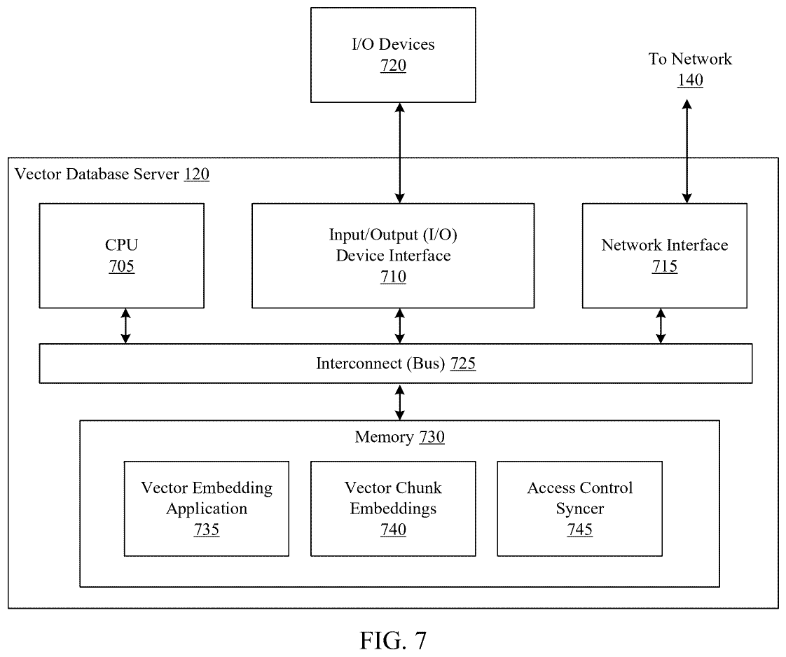

FIG. 7 is a block diagram of a vector database server 120 that may be implemented in conjunction with the computing system 100, according to the present teachings. In some examples, the vector database server 120 is integrated with one or more servers included in the database servers 145.

As shown, the vector database server 120 includes, without limitation, a CPU 705, an input/output (I/O) devices interface 710, a network interface 715, I/O devices 720, an interconnect 725, and a system memory 730. The CPU 705 is configured to retrieve and execute programming instructions, such as a vector embedding application 735. Similarly, the CPU 705 is configured to store application data (e.g., software libraries) and retrieve application data from the system memory 730. The interconnect 725 is configured to facilitate transmission of data, such as programming instructions and application data, between the CPU 705, I/O devices interface 710, the network interface 715, and the system memory 730. The I/O devices interface 710 is configured to receive input data from I/O devices 720 and transmit the input data to the CPU 705 via the interconnect 725. For example, I/O devices 720 may include one or more buttons, a keyboard, a mouse, and/or other input devices. The I/O devices interface 710 is further configured to receive output data from the CPU 705 via the interconnect 725 and transmit the output data to the I/O devices 720.

The system memory 730 may be provided in the form of a single memory unit or multiple memory units and may be one or more articles of manufacture and/or machine components. The system memory 730 may include static memory, dynamic memory, or both in communication. In some examples, the system memory 730 may be one or more tangible storage mediums that can store data and executable instructions and may be non-transitory during the time instructions are stored therein. The system memory 730 includes a vector embedding application 735 that services requests from the record database server 115 to generate and store vector embeddings and to modify access control information associated with vector embeddings. For example, the system memory 730 further includes a collection of vector chunk embeddings 740 and an access control syncer 745 for syncing the access control associated with the vector chunk embeddings 740.

Responsive to receiving a new record from the record database server 115, the vector embedding application 735 can chunk the record into segments and generate a plurality of vector chunk embeddings 740, each including vector data for a respective segment of the record. Each record segment may correspond to a page of the record, a paragraph in the record, a sentence included in the record, a frame (e.g., a video frame), a model part (e.g., of a 3D model), a table, or other type of segment based on the received record. Each vector chunk embedding 740 can further include a reference to access control information associated with the received record. The reference to access control information is, for example, a reference to the access control mapping of user groups to a record.

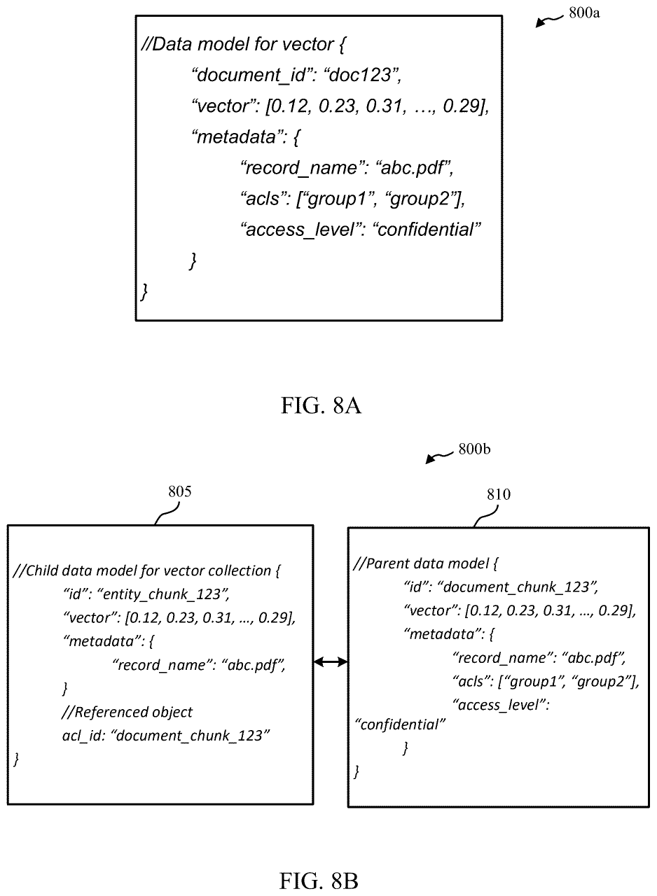

FIG. 8A illustrates an example vector chunk embedding 800a, according to the present teachings. In the example of FIG. 8A, the vector chunk embedding 800a includes an identifier of the record chunk and/or vector chunk embedding, vector data indicative of the record chunk, and metadata associated with the record chunk. The metadata includes, for example, an identification of the record from which the record chunk is derived (e.g., the record file name and/or record ID), the reference to the access control information of the record, a level of access associated with the record (e.g., confidential, public, etc.), and/or a combination thereof.

In the example of FIG. 8A, the reference to the access control information (e.g., “acls”) is directly embedded in the structure of vector chunk embedding 800a. For example, the reference to the access control information indicates which user groups (e.g., group1 and group 2) have access to the record. As such, the vector chunk embedding 800a may otherwise be referred to herein as the embedded structure 800a.

In some examples, the reference to the access control information of the record is chunk-specific access control information. In that regard, vector chunks associated with the same record can be mapped to different sets of user groups. As an example, the record database server 115 may store, as a record, a research paper to which only one user group has full access to. However, multiple user groups may have access to the abstract of the research paper. In such examples, the vector embedding application 735 can generate vector chunk embeddings associated with the record, wherein the access control information (e.g., user group mappings) associated with each vector chunk embedding may differ from one another. For example, access control information in a vector chunk embedding corresponding to the abstract of the research paper may multiple user groups permitted to access the vector chunk embedding, whereas access control information in a vector chunk embedding corresponding to the body of the research paper may include only a single user group. In this manner, the vector database server 120 can provide not only record-level access control, but also chunk-level access control.

FIG. 8B illustrates another example vector chunk embedding 800b, according to the present teachings. In the example of FIG. 8B, the vector chunk embedding 800b includes a child structure, or child vector embedding, 805 and a parent structure, or parent vector embedding, 810. The child vector embedding 805 and the parent vector embedding 810 can reference one another, and as such, the vector chunk embedding 800b may otherwise be referred to herein as the cross-referenced structure 800b. In some examples, the parent vector embedding 810 stores vector embedding data related to a record as a whole, while the child vector embedding 805 stores vector embedding data related to a respective chunk or segment of the record. The parent vector embedding 810 can be associated with any number of child structures 805 (e.g., each corresponding to a respective segment of the record), and each child structure points to, or references, a parent vector embedding 810.

In some examples, the child vector embedding 805 includes an identifier of the record chunk and/or an identifier of the child vector embedding 805 (e.g., as “id”), vector data of the record chunk, metadata associated with the child vector embedding 805, and a reference to the access control information of the record with which the child vector embedding 805 is associated. The metadata of the child vector embedding 805 includes, for example, an identification of the record from which the record chunk is derived (e.g., the record file name and/or record ID). In the child vector embedding 805, the reference to the access control information is a reference to the parent vector embedding 810.

In some examples, the parent vector embedding 810 includes an identifier of the record and/or an identifier of the parent vector embedding 810 (e.g., as “id”), vector data of the record, and metadata of the parent vector embedding 810. The metadata includes, for example, the identification of the record from which one or more record chunks are derived (e.g., the record file name and/or record ID), the access control mapping for the record (e.g., an indication of the set of user groups having access to the record), and a level of access associated with the record (e.g., confidential, public, etc.).

The cross-referenced structure 800b provides for more efficient modification of the access control information stored in the vector database server 120. For example, in operation, the vector embedding application 735 can detect a modification to the access control information associated with a record. Then, using the cross-referenced structure 800b, the vector embedding application 735 can propagate the modification by simply updating the reference to the access control information in the parent vector embedding 810 for the record as a whole, rather than needing to update all of the vector chunk embeddings associated with the record segments.

Referring again to FIG. 7, in some examples, the vector embedding application 735 can detect the changes in the access control information of records via the access control syncer 745. For example, the access control syncer 745 can receive notifications (e.g., queue notifications) of access control changes from the record database server 115 via the network interface 715. In some examples, access control syncer 745 includes an automatic vector scaler for efficient modification of the vector chunk embeddings 740.

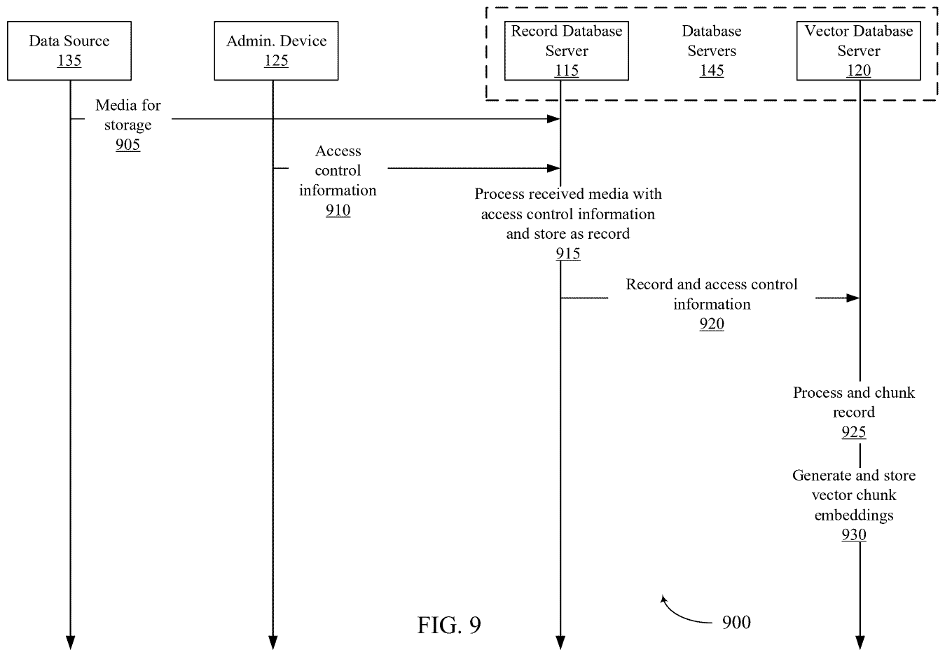

FIG. 9 illustrates an example flow diagram of a process 900 for storing vector chunk embeddings in the vector database server 120, according to the present teachings. Although the interaction between the devices in process 900 are shown in an order, persons skilled in the art will understand that the interactions may be performed in a different order, interactions may be repeated or skipped, and/or may be performed by components other than those described in FIG. 9. Further, persons skilled in the art will understand that one or more operations described with respect to FIG. 9 may be performed using a different component of the computing system 100.

At step 905, the record database server 115 receives (e.g., using server application 635), from the data source 135, media for record storage. As described above, the media may include text data, image data, audio data, video data, seismic data, well logging data, wellbore production data, reservoir data, geospatial data, 3D modeling data, or combinations thereof. In some examples, the record database server 115 receives the media directly from the data source 135. However, in other examples, the record database server 115 receives the media via an intermediary device, such as the administrative computing device 125, the search engine server 105, or another device.

At step 910, the record database server 115 receives, from the administrative computing device 125, access control information associated with the media. The access control information can indicate a set of user groups that are granted access to the media. The set of user groups includes, for example, user groups that are defined by one or more access control policies and/or stored in the access control server 110. In some examples, the access control information indicates a default level of access associated with the media (e.g., public, confidential, or the like). In some examples, the access control information indicates individual users that are granted access to the media.

At step 915, the record database server 115 processes the received media along with the received access control information and stores a record of the media. As described above, processing the media can include performing an OCR with respect to the media, generating a transcription of the media, generating classifications of the record, and/or extracting other data from the record. In generating and storing the record, the record database server 115 can additionally update the access control mappings (e.g., access control information 645) to include an indication of the record (e.g., a record ID) and the received access control information associated with the record.

At step 920, the record database server 115 transmits, to the vector database server 120, the record and the access control information associated with the record. In some examples, the record database server 115 transmits one or both of the record and the corresponding access control information to the vector database server 120 via a queue (e.g., a message queue).

At step 925, responsive to receiving the record and the access control information associated with the record, the vector database server 120 processes and chunks (e.g., using vector embedding application 735) the record. In some examples, processing the record includes extracting data from the record, such as OCR data, transcription data, one or more classifications, and/or other data. As described above, the vector database server 120 can chunk the record into segments by pages, paragraphs, headings, sentences, frames, clips, parts, or the like.

At step 930, the vector database server 120 generates and stores vector chunk embeddings (e.g., at least one vector chunk embedding) corresponding to the generated record chunks. As described above, the vector database server 120 can generate the vector chunk embeddings according to the embedded model of FIG. 8A, the cross-referenced model of FIG. 8B, and/or another vector embedding model. The vector chunk embeddings store vector data associated with corresponding record chunks (e.g., record segments) and the access control information associated with the record. As described above, in some examples, the access control information includes chunk-specific access control information.

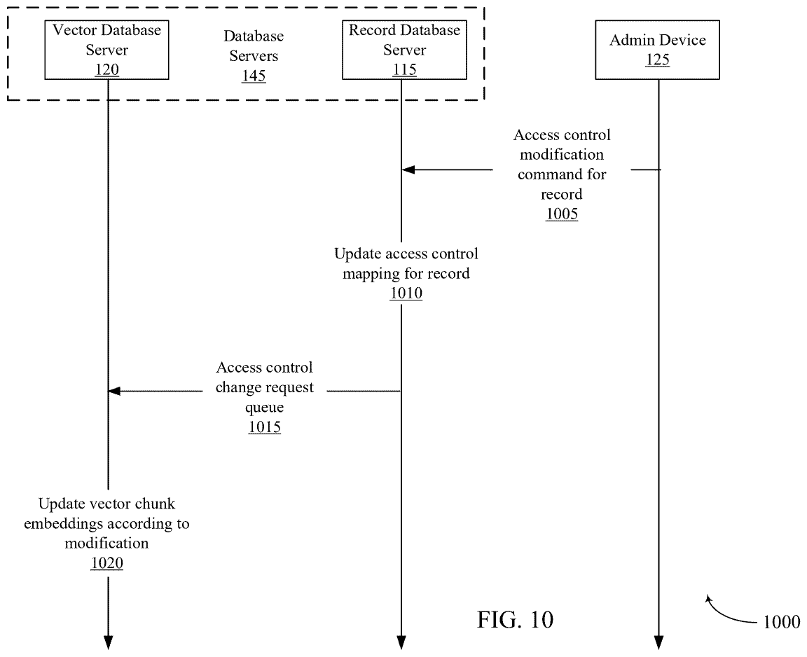

FIG. 10 illustrates an example flow diagram of a process 1000 for modifying access control policies implemented in conjunction with a search engine, according to the present teachings. Although the interaction between the devices in process 1000 are shown in an order, persons skilled in the art will understand that the interactions may be performed in a different order, interactions may be repeated or skipped, and/or may be performed by components other than those described in FIG. 10. Further, persons skilled in the art will understand that one or more operations described with respect to FIG. 10 may be performed using a different component of the computing system 100.

At step 1005, the record database server 115 receives (e.g., using server application 635), from an administrative computing device 125, a request or command to modify access control information (e.g., the access control information 645) associated with one or more selected records (e.g., of the records 640 stored in the record database server 115). The request can include, for example, a request to add a user group to the access control mapping of a selected record, to remove a user group from the access control mapping of the selected record, to modify a default level of access for the selected record, or a combination thereof.

At step 1010, the record database server 115 updates the access control mapping of the selected record according to the request. In some examples, the record database server 115 transmits a response (e.g., an acknowledgment) to the administrative computing device 125 responsive to updating the access control mapping. As described herein, updating an access control mapping for a record is just one type of modification that can be made to an access control policy.

At step 1015, the vector database server 120 detects (e.g., using vector embedding application 735) the modification of the access control information for the selected record, for example, via an access control change notifier associated with the record database server 115. For example, the record database server 115 can propagate the modification to the access control policy to the vector database server 120 using a queue service, and the vector database server 120 can listen for messages on the queue.

At step 1020, the vector database server 120 updates the vector chunk embeddings associated with the selected record (e.g., included in the vector chunk embeddings 740) according to the modification (e.g., using the access control syncer 745). For example, the vector database server 120 can identify each vector chunk embedding that is associated with the selected record (e.g., as indicated by the metadata of the vector chunk embeddings), and can update the reference to access control information in the identified vector chunk embeddings based on the detected modification.

As described above, in some examples, the vector chunk embeddings follow a cross-referenced model rather than an embedded model. In such examples, the vector database server 120 can update the parent vector embedding associated with the selected record according to the modification and refrain from modifying the child vector embeddings. As described above, the reference to access control information in the child vector embeddings is a reference to the parent vector embedding. Therefore, the vector database server 120 need not modify the child vector embeddings in order to propagate the modification to the access control policy to the vector chunk embeddings 740 when implementing the cross-referenced structure. In this manner, the vector database server 120 can more effectively manage and retain the access control policies of the database servers 145, and can reduce the risk of discrepancies in access control between different components of the database servers 145.

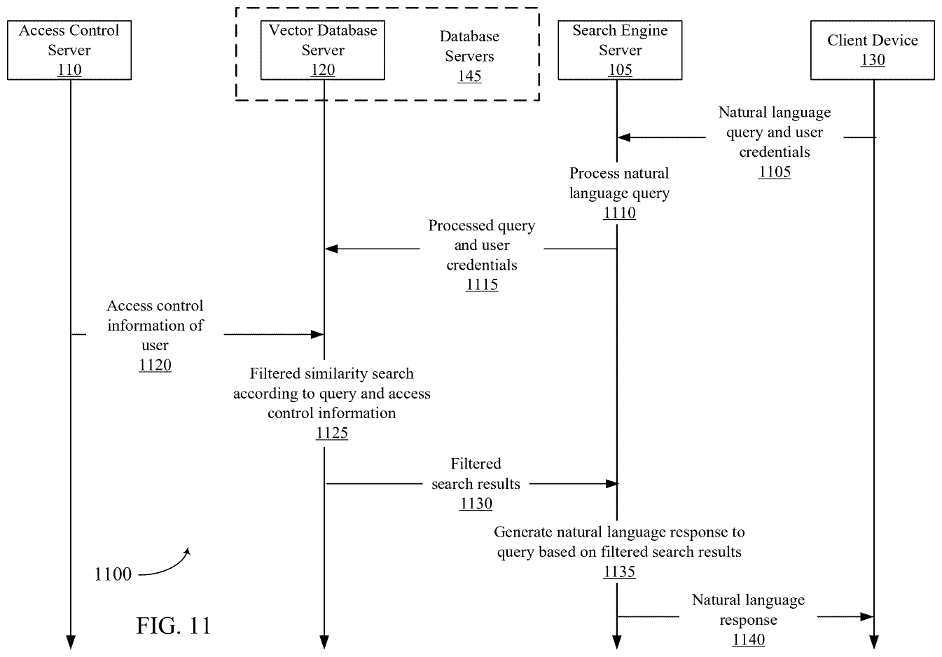

FIG. 11 illustrates an example flow diagram of a process 1100 for performing a semantic search, according to the present teachings. Although the interaction between the devices in process 1100 are shown in an order, persons skilled in the art will understand that the interactions may be performed in a different order, interactions may be repeated or skipped, and/or may be performed by components other than those described in FIG. 11. Further, persons skilled in the art will understand that one or more operations described with respect to FIG. 11 may be performed using a different component of the computing system 100. For example, one or more functions performed by the search engine server 105 may alternatively be performed by the vector database server 120 and/or the access control server 110.

At step 1105, the search engine server 105 receives (e.g., using semantic search service 235) a natural language query and user credentials from a client computing device 130. The user credentials identify a user of the client computing device 130. As described above, in some examples, the search engine server 105 receives the user credentials of the client computing device 130 separate from the natural language query. For example, the search engine server 105 can receive the user credentials upon initiation of an application session by the client computing device 130.

At step 1110, the search engine server 105 processes the natural language query and/or the user credentials. Processing the natural language query can include tokenizing the query, normalizing the query, and/or other processing of the query. In some examples, processing the query includes vectorizing the query. In some examples, the search engine server 105 processes the query using the LLM 240. Processing the user credentials can include, for example, extracting a user ID of the user credentials as registered to the database servers 145.

At step 1115, the search engine server 105 transmits the processed query and user credentials to the vector database server 120. The vector database server 120 receives (e.g., using the vector embedding application 735) the query and the user credentials via the search engine server 105. At step 1120, the vector database server 120 retrieves the access control information associated with the user of the client computing device 130 from the access control server 110 (e.g., from the access control information 540). The vector database server 120 can retrieve the access control information by transmitting a request to the access control server 110 that includes the user credentials of the user of the client computing device 130. The received access control information can include an indication of the set of all user groups of which the user of the client computing device 130 is a member.

At step 1125, the vector database server 120 performs a filtered similarity search of the vector chunk embeddings 740 according to the query and the access control information of the user. The filtered similarity search is, for example, a vector similarity search of the vector chunk embeddings 740 based on a vectorization of the natural language query. In some examples, the filtered similarity search is an approximate nearest neighbor (ANN)-based vector search. Each vector chunk embedding returned in the search results includes, as respective access control information, at least one user group of which the user of the client computing device 130 is a member. That is, in performing the filtered similarity search, the vector database server 120 removes or otherwise does not include vector chunk embeddings that are not associated with a set of users that includes the user of the client computing device 130. In this regard, the vector database server 120 does not return vector chunk embeddings associated with data records and/or record chunks that the user is not permitted to access.

By way of example, if the user of the client computing device 130 is only a member of user group 1 and user group 2, then the filtered similarity search results do not include a confidential vector chunk embedding having access control information associated with only user group 3, in which the user is not a member. In this manner, the vector database server 120 manages and retains the access control policies of the system 100.

At step 1130, the vector database server 120 returns the filtered similarity search results to the search engine server 105 (e.g., to the LLM 240). At step 1135, the search engine server 105 generates a natural language response to the query using the LLM 240 based on the filtered similarity search results received from the vector database server 120. At step 1140, the search engine server 105 transmits the natural language response to the client computing device 130. In some examples, transmitting the natural language response to the client computing device 130 further includes transmitting the records or a reference to the records (e.g., one or more links) associated with the vector chunk embeddings returned in the filtered search results of step 1130.

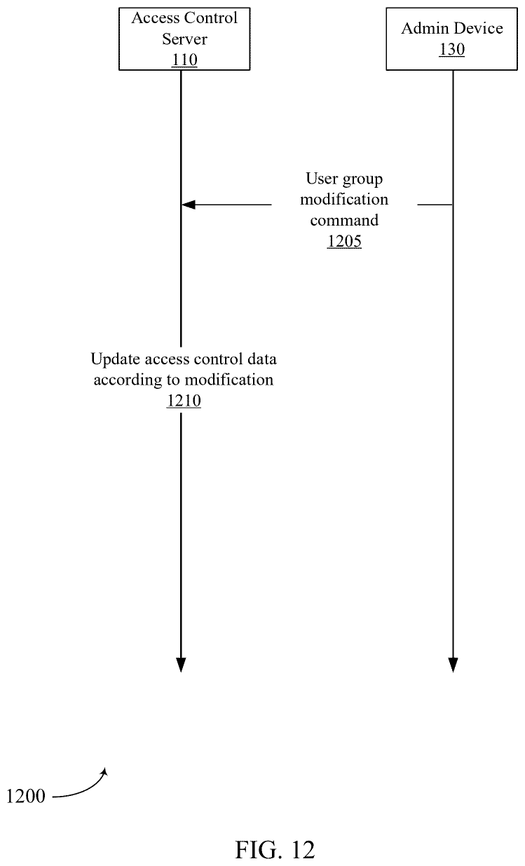

FIG. 12 illustrates an example flow diagram of a process 1200 for modifying access control policies implemented in conjunction with a search engine, according to the present teachings. Although the interaction between the devices in process 1200 are shown in an order, persons skilled in the art will understand that the interactions may be performed in a different order, interactions may be repeated or skipped, and/or may be performed by components other than those described in FIG. 12. Further, persons skilled in the art will understand that one or more operations described with respect to FIG. 12 may be performed using a different component of the computing system 100.

At step 1205, the access control server 110 receives (e.g., using the server application 535), from an administrative computing device 125, a user group modification command. The modification command can include a command to create one or more new user groups, to delete one or more selected user groups, to add one or more selected users to a selected user group, to remove one or more selected users from a selected user group, or a combination thereof.

At step 1210, the access control server 110 updates the access control information 540 according to the modification. To update the access control information 540, the access control server 110 updates the mapping of system users to user groups to reflect the requested modification (e.g., to create a new user group, to delete a user group, to add a user to a user group, to remove a user to a user group). In some examples, the access control server 110 transmits an acknowledgement or other confirmation of the modification to the administrative computing device 125.

The computing system 100 facilitates more efficient and accurate modification of access control policies by managing the mappings of user groups to records separately from mappings of users to user groups. For example, access control of records and vector chunk embeddings are both mapped to user groups rather than to individual users. Therefore, granting or revoking access for an individual user to a record does not necessarily require a modification to the access control information 645 of the record database server 115 and to the vector chunk embeddings 740 of the vector database server 120. Rather, the access control server 110 can simply update the affected mapping of users to user groups (e.g., in the access control information 540) to grant or revoke record access for the individual user. During semantic searching (e.g., according to the process 1100 of FIG. 11), the vector database server 120 retrieves the up-to-date user group mappings from the access control server 110.

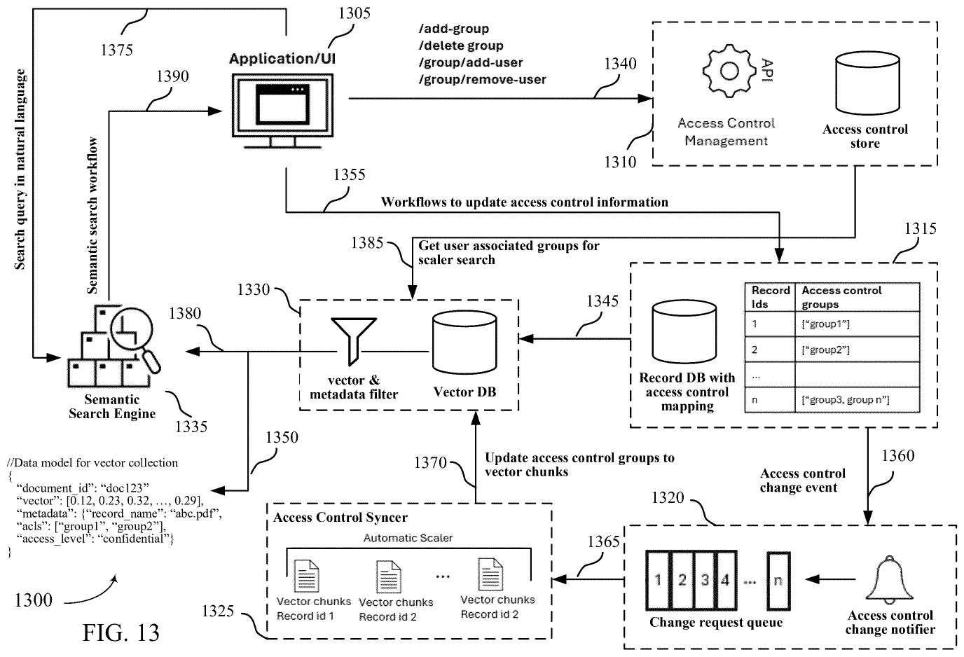

FIG. 13 illustrates a workflow that may be implemented in conjunction with a computing system 1300, according to the present teachings. The system 1300 may be, or include aspects of, the computing system 100. The system 1300 may include a computing device 1305, an access control database 1310, a record database 1315, an access control change notifier 1320, an access control syncer 1325, a vector database 1330, and a semantic search engine 1335. The computing device 1305 may be, or include aspects of, the administrative computing device 125 and/or the client computing device 130.

The access control database 1310 can include one or more application programming interfaces (APIs) for interfacing with the computing device 1305, and can store, as part of an access control policy, access control information that maps users of the system 1300 to defined access control groups (e.g., user groups). The access control database 1310 may be implemented by, for example, the access control server 110.

The record database 1315 can store copies of records that may be referenced by a semantic search engine (e.g., the semantic search engine 1335) for generating response to queries. The record database 1315 can additionally store, as part of an access control policy, access control information that maps each of the stored records to defined access control groups (e.g., user groups). The record database may be implemented by, for example, the record database server 115.

The access control change notifier 1320 listens for changes to the access control mappings of the record database 1315. The access control change notifier 1320 may be implemented by, for example, the record database server 115 and/or the vector database server 120.

The access control syncer 1325 uses a vector scaler to sync access control changes of the record database 1315 with the vector database 1330. The access control syncer 1325 may be implemented by, for example, the vector database server 120.

The vector database 1330 stores vector chunk embeddings based on records held by the record database 1315. The vector database 1330 may be implemented by, for example, the vector database server 120. The semantic search engine 1335 may be implemented by, for example, the search engine server 105.

The computing device 1305 can transmit a user group modification command 1340 to the access control database 1310. The user group modification command 1340 can be a command to add a user group to the access control database 1310, a command to delete a user group from the access control database 1310, a command to add a user to the access control database 1310, or a command to remove a user from the access control database 1310. Responsive to receiving the command 1340, the access control database 1310 updates the mapping of users to user groups in accordance with the command 1340.

The vector database 1330 can receive a new record 1345 from the record database 1315. Responsive to receiving the record 1345, the vector database can chunk and vectorize the record 1345 to generate and store one or more vector chunk embeddings 1350 associated with the record. Each vector chunk embedding 1350 can include the access control mapping data associated with the record 1345. Each vector chunk embedding 1350 may adhere to the embedded vector model described with respect to FIG. 8A, the cross-referenced vector model described with respect to FIG. 8B, or another model type.

The computing device 1305 can transmit, to the record database 1315, a command 1355 to modify the access control information associated with a record. The command 1355 can be a command to add a user group to an access control mapping of a record or to remove a user group from the access control mapping of a record. Responsive to receiving the command 1355, the record database 1315 updates the mapping of records to user groups in accordance with the command 1355.

The access control change notifier 1320 can detect an access control change event 1360 associated with the record database 1315 (e.g., responsive to the record database 1315 updating the mapping of records according to the command 1355). The access control change notifier 1320 can propagate the detected access control change event 1360 by adding a request for the change to a change request queue and outputting a notification 1365 of the change to the access control syncer 1325.

The access control syncer 1325 receives the notification 1365 of the change and searches (e.g., using an automatic vector scaler) for vector chunk embeddings 1350 stored in the vector database 1330 that are associated with the modified record. The access control syncer 1325 applies the same modification of the access control information to the affected vector chunk embeddings in accordance with the notification 1365. For example, the access control syncer 1325 can transmit a command 1370 to update the access control information of the identified vector chunk embeddings in accordance with the notification 1365.

The user interface device 1305 can transmit a natural language query 1375 to the semantic search engine 1335. The semantic search engine 1335 can vectorize the natural language query 1375 and retrieve a set of filtered vector similarity search results 1380 from the vector database 1330 based on the vectorization of the natural language query 1375.

The vector database 1330 can retrieve, from the access control database 1310, the set of user groups 1385 to which a user of the user interface device 1305 is a member. The vector database 1330 can then filter the searchable vector chunk embeddings 1350 according to the retrieved set of user groups 1385 and perform the vector similarity search based on the natural language query 1375.

The semantic search engine 1335 receives the filtered vector similarity search results 1380, and uses the filtered vector similarity search results 1380 to generate a response 1390 to the natural language query 1375. The semantic search engine 1335 outputs the response 1390 to the user interface device 1305.

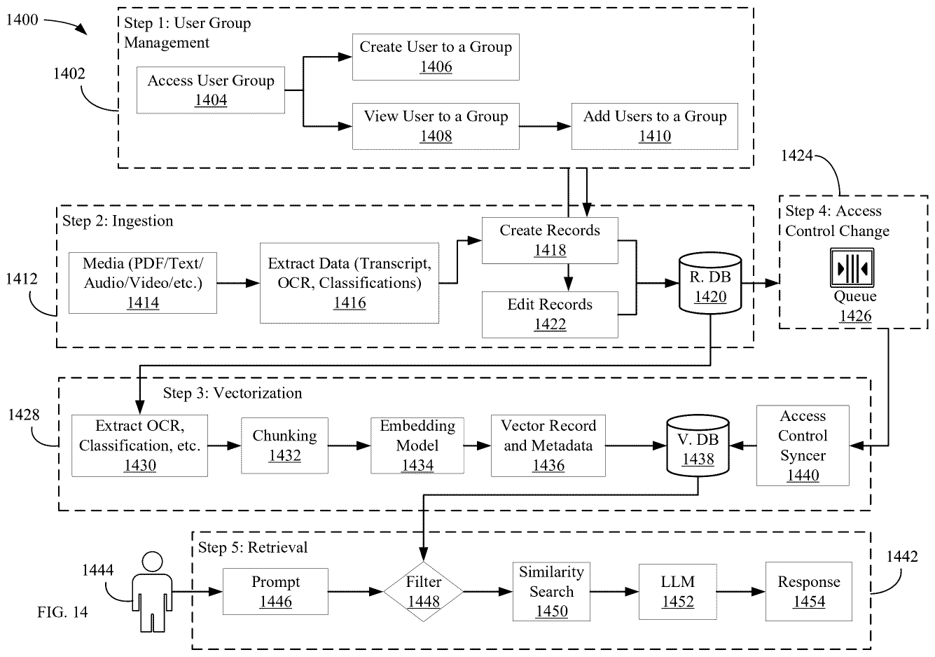

FIG. 14 illustrates an example flow diagram of method steps 1400 for configuring access control policies implemented in conjunction with a search engine, according to the present teachings. Although the interaction between the devices in the method steps 1400 are shown in an order, persons skilled in the art will understand that the interactions may be performed in a different order, interactions may be repeated or skipped, and/or may be performed by components other than those described in FIG. 14. Further, persons skilled in the art will understand that one or more operations described with respect to FIG. 9 may be performed using a different component of the computing system 100.

The method steps 1400 can include a user group management step 1402. In some examples, the user group management step 1402 is performed by the access control server 110 (e.g., using the server application 535) in conjunction with an administrative computing device 125. The user group management step 1402 may include receiving user input to access a user group (e.g., a selected user group) that is registered to the database servers 145 and stored in the access control information 540 (at block 1404). Accessing the user group can include transmitting, with the access control server 110, information related to a selected user group (e.g., members, group name, access control levels, associated records, etc.) for display on the administrative computing device 125.

The user group management step 1402 can include receiving user input to create a new user for a group (at block 1406). In some examples, a new user is a user that is not yet registered in the access control information 540. Creating a new user for a group can therefore include registering, with the access control server 110, the new user to the database servers 145 and mapping or assigning the new user to one or more user groups.

The user group management step 1402 can include receiving user input to view one or more users mapped to a selected group (at block 1408). Responsive to receiving the user input, the access control server 110 outputs, to the administrative computing device 125, information related to the one or more users mapped to the selected group (e.g., all users mapped to the selected group, an individual user mapped to the selected group, additional information related to the selected group, etc.). The user group management step 1402 can include receiving user input to add one or more users to the selected group (at block 1410). Responsive to receiving the user input, the access control server 110 updates the access control information 540 to add the one or more users to the selected group.

The method steps 1400 can include a data ingestion step 1412. In some examples, the data ingestion step 1412 is performed by the record database server 115. The data ingestion step 1412 can include receiving (e.g., from a data source 135) one or more media files, such as a portable document format (PDF) file, a text document file, an audio file, a video file, or another file type (at block 1414). The data ingestion step 1412 can include extracting data from the received media file, such as a transcript, an OCR, classifications, or the like (at block 1416).

Responsive to receiving and processing the one or more media files, the record database server 115 creates one or more records of the media files (at block 1418), and stores the one or more records to a record database (at block 1420). Each record can include a copy of the corresponding media file and/or the extracted data of the corresponding media file. Creating a record can also include storing a mapping of the record to one or more user groups based on information received from the access control server 110 (e.g., information generated during the user group management step 1402). In some examples, the user group management step 1402 is performed responsive to the record database server 115 receiving the media file at block 1414.

In some examples, the data ingestion step 1412 includes modifying or editing a record stored in the record database (at block 1422) based on changes to the user group mappings of the record, such as changes made during the user group management step 1402. The record database server 115 can update the access control information associated with the record based on the modification, and store the update to the record database (at block 1420).

The method steps 1400 can include an access control policy modification step 1424. In some examples, the access control policy modification step 1424 is performed by the record database server 115, the vector database server 120, and/or another component operating in conjunction with the record database server 115 and the vector database server 120. The access control policy modification step 1424 includes detecting (e.g., using a listener component) a modification to the record database (e.g., a modification to the records 640 and/or access control information 645 of the record database server 115) (at block 1426). The modification can be detected in response to creation of a new record (e.g., at block 1418) and/or in response to modification of the access control information associated with a record (e.g., at block 1422). Detecting the modification can include updating a queue based on the modification to notify the vector database server 120 of the change.

The method steps 1400 can include a vectorization step 1428. In some examples, the vectorization step 1428 is performed by the vector database server 120. The vectorization step 1428 can include receiving a record from the record database (e.g., the record database server 115), and extracting data from the record (at block 1430). The data extracted can include the transcription, the OCR, the classifications, or other data extracted at, for example, block 1416 of the method steps 1400.

The vectorization step 1428 can include chunking the received record into a plurality of segments or record chunks (at block 1432), and vectorizing each of the chunks according to a vector embedding model (at block 1434). The vector database server 120 generates a plurality of vector records each corresponding to at least one record chunk (at block 1436). In some examples, each vector record includes metadata indicative of the user groups having access to the corresponding record stored in the record database. The vector database server 120 stores the generated vector records to a vector database (e.g., to the vector chunk embeddings 740) (at block 1438).

The vectorization step 1428 can include detecting, with an access control syncer (e.g., the access control syncer 745) a modification to the access control policy associated with one or more records (at block 1440). For example, the vector database server 120 can receive a notification of a change via an access control change queue (e.g., a notification generated during the access control policy modification step 1424). The vector database server 120 identifies vector chunk embeddings in the vector database that are associated with the modified record, and updates the identified vector chunk embeddings according to the modification (e.g., to add or remove groups mapped to the identified vector chunk embeddings). Modifying the identified vector chunk embeddings can include modifying the metadata of the identified vector chunk embeddings.

The method steps 1400 can include a vector retrieval step 1442. In some examples, the vector retrieval step 1442 is performed by the search engine server 105 in conjunction with the vector database server 120. The vector retrieval step 1442 can include receiving a prompt from a user 1444 (e.g., a user of a client computing device 130) (at block 1446). The prompt may be, for example, a natural language search query or other natural language prompt. The vector database server 120 determines an identity of the user 1444, and filters the vector records stored in the vector database according to the user groups with which the user 1444 is associated (at block 1448). The vector database server 120 performs a similarity search on the filtered vector records with respect to the received prompt (at block 1450). In some examples, the vector database server 120 performs the similarity search prior to or during filtering of the vector records according to the user groups of the user 1444.

The vector retrieval step 1442 can include outputting the filtered similarity search results to an LLM (e.g., the LLM 24) (at block 1452) to generate a natural language response to prompt (at block 1454). The natural language response can be output to the user 1444 via the client computing device 130.

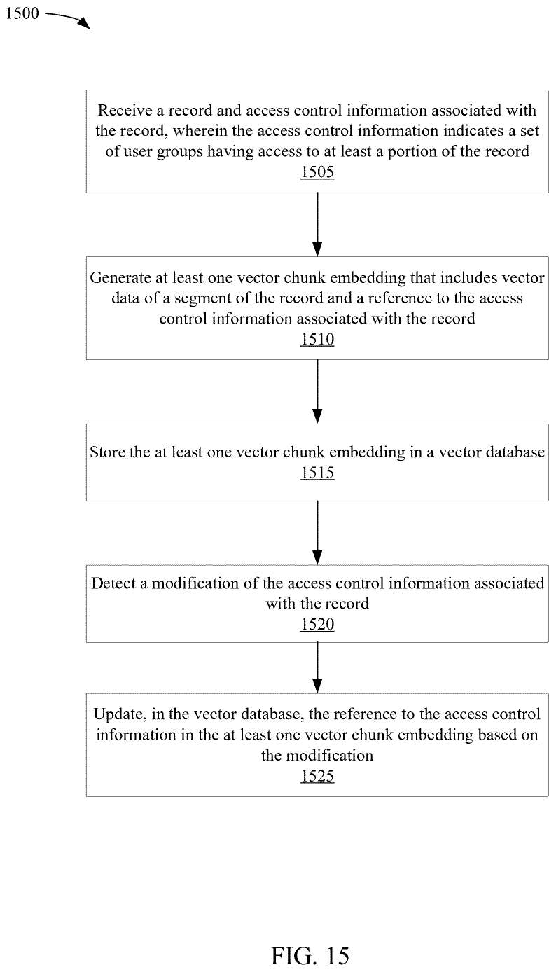

FIG. 15 illustrates an example flow diagram of method steps 1500 for enforcing access control policies implemented in conjunction with a search engine, according to the present teachings. Although the method steps 1500 are described with reference to the systems and processes of FIGS. 1-14, persons skilled in the art will understand that any system configured to implement the method steps, in any order, falls within the scope of the present invention.

The method steps 1500 include receiving a record and access control information associated with the record (at block 1505). The access control information indicates a set of user groups having access to at least a portion of the record. For example, the vector database server 120 may receive the record and access control information associated with the record from the record database server 115.

The method steps 1500 include generating at least one vector chunk embedding that includes vector data of a segment of the record and a reference to the access control information associated with the record (at block 1510). For example, the vector database server 120 may generate the at least one vector chunk embedding according to an embedded model or a cross-referenced model.

The method steps 1500 include storing the at least one vector chunk embedding in a vector database (at block 1515).

The method steps 1500 include detecting a modification of the access control information associated with the record (at block 1520). For example, the vector database server 120 may detect the modification using a queue or other channel between the record database server 115 and the vector database server 120.

The method steps 1500 include updating, in the vector database, the reference to the access control information in the at least one vector chunk embedding based on the modification (at block 1525). For example, the vector database server 120 may use a vector scaler to search for vector chunk embeddings associated with the affected record and update the reference to access control information associated with the identified vector chunk embeddings.

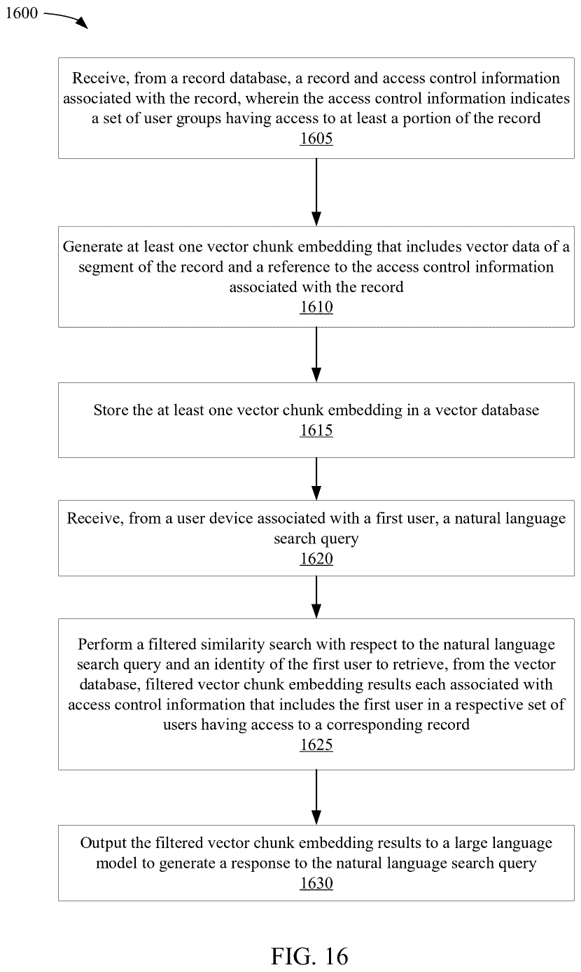

FIG. 16 is a flow diagram of method steps 1600 for performing a semantic search, according to the present teachings. Although the method steps are described with reference to the systems and processes of FIGS. 1-14, persons skilled in the art will understand that any system configured to implement the method steps, in any order, falls within the scope of the present invention.

The method steps 1600 include receiving, from a record database, a record and access control information associated with the record, wherein the access control information indicates a set of user groups having access to at least a portion of the record (at block 1605).

The method steps 1600 include generating at least one vector chunk embedding that includes vector data of a segment of the record and a reference to the access control information associated with the record (at block 1610).

The method steps 1600 include storing the at least one vector chunk embedding in a vector database (at block 1615).

The method steps 1600 include receiving, from a computing device associated with a first user, a natural language search query (at block 1620). The vector database server 120 may receive the natural language query directly from the client computing device 130 or via an intermediary device (e.g., the search engine server 105). For example, the vector database server 120 may receive a processed (e.g., tokenized and/or vectorized) format of the natural language search query.

The method steps 1600 include performing a filtered similarity search with respect to the natural language search query and an identity of the first user to retrieve, from the vector database, filtered vector chunk embedding results each associated with access control information that includes the first user in a respective set of users having access to a corresponding record (at block 1625). For example, the vector database server 120 determines an identity of the user of the client computing device 130, retrieves the set of user groups to which the user of the client computing device 130 belongs, and filters the stored vector chunk embeddings based on the set of user groups to which the user belongs.

The method steps 1600 include outputting the filtered vector chunk embedding results to a large language model to generate a response to the natural language search query (at block 1630).

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot vectorize data, store vector embeddings, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A computing system comprising:
at least one memory storing an access control service; and
at least one processor in communication with the at least one memory, the at least one processor configured to execute the access control service to cause the at least one processor to:
receive a record and access control information associated with the record, wherein the access control information indicates a set of user groups having access to at least a portion of the record;
generate, based on the record, at least one vector chunk embedding that includes vector data associated with a segment of the record and a reference to the access control information associated with the record;
store the at least one vector chunk embedding in a vector database;
detect a modification to the access control information associated with the record; and
responsive to detecting the modification, update, in the vector database, the reference to the access control information in the at least one vector chunk embedding based on the modification.

2. The computing system of claim 1, wherein the modification includes at least one of an addition of a user group to the set of user group a having access to at least a portion of the record, a removal of a user group from the set of user groups having access to at least a portion of the record, a change to a default access level for the record, or a combination thereof.

3. The computing system of claim 1, wherein detecting the modification to the access control information associated with the record includes receiving a notification of a queue event, wherein the queue event is indicative of the modification.

4. The computing system of claim 1, wherein:
the at least one vector chunk embedding includes a child vector embedding and a parent vector embedding,
in the child vector embedding, the reference to the access control information associated with the record is a reference to the parent vector embedding,
in the parent vector embedding, the reference to the access control information associated with the record includes an indication of the set of user groups having access to at least a portion of the record, and
to update the at least one vector chunk embedding based on the modification to the access control information, the at least one processor updates the reference to the access control information in the parent vector embedding.

5. The computing system of claim 4, wherein the at least one vector chunk embedding includes a plurality of child vector embeddings,
wherein each child vector embedding included in the plurality of child vector embeddings includes vector data associated with a respective segment of the record, and
wherein each child vector embedding included in the plurality of child vector embeddings includes the reference to the parent vector embedding.

6. The computing system of claim 4, wherein at least one of the parent vector embedding, the child vector embedding, or a combination thereof further includes a reference to the record stored in a record database.

7. The computing system of claim 1, wherein executing the access control service further causes the at least one processor to:
receive, from a computing device associated with a first user, a natural language search query;
perform, based on the natural language search query and access control policy associated with the first user, a filtered similarity search to retrieve, from the vector database, a vector chunk embedding that includes access control information associated with the first user;
output the filtered vector chunk embedding to a large language model; and
generate, based on filtered vector chunk embedding, a response to the natural language search query.

8. A computing system comprising:
at least one memory storing a semantic search service; and
at least one processor in communication with the at least one memory, the at least one processor configured to execute the semantic search service to cause the at least one processor to:
receive, from a record database, a record and access control information associated with the record, wherein the access control information indicates a set of users having access to at least a portion of the record;
generate, based on the record, at least one vector chunk embedding that includes vector data associated with a segment of the record and a reference to the access control information associated with the record;
store the at least one vector chunk embedding in a vector database;
receive, from a computing device associated with a first user, a natural language search query;
perform, based on the natural language search query and an access control policy associated with the first user, a filtered similarity search to retrieve, from the vector database, a filtered vector chunk embedding that includes access control information associated with the first user; and
output the filtered vector chunk embedding to a large language model to generate a response to the natural language search query.

9. The computing system of claim 8, wherein the record database stores a collection of records and a mapping of access control information for each record included in the collection of records.

10. The computing system of claim 9, wherein executing the semantic search service further causes the at least one processor to:
receive, from an open subsurface data universe (OSDU) platform, oilfield services and technology (OST) data;
process the OST data to generate the collection of records;
receive access control information for each record included in the collection of records;
map the access control information to each record included in the collection of records; and
store the collection of records and a mapping of access control information to the record database.

11. The system of claim 8, wherein the record includes at least one of text data, image data, video data, audio data, seismic data, well logging data, wellbore production data, reservoir data, or and geospatial data.

12. The system of claim 8, wherein executing the semantic search service further causes the at least one processor to:
process the record to generate transcript of the record, to perform an optical character recognition (OCR) on the record, to identify one or more classifications for the record, or a combination thereof.

13. A computer-implemented method, comprising:
receiving, from a record database, a record and access control information associated with the record, wherein the access control information indicates a set of users having access to at least a portion of the record;
generating at least one vector chunk embedding that includes vector data associated with a segment of the record and a reference to the access control information associated with the record;
storing the at least one vector chunk embedding in a vector database;
detecting a modification to the access control information associated with the record; and
responsive to detecting the modification, updating, in the vector database, the reference to the access control information in the at least one vector chunk embedding based on the modification.

14. The computer-implemented method of claim 13, wherein the at least one vector chunk embedding includes a plurality of vector chunk embeddings, and each vector chunk embedding included in the plurality of vector chunk embeddings is associated with a respective segment of the record, and
wherein each vector chunk embedding included in the plurality of vector chunk embeddings includes a respective reference to the access control information associated with the record.

15. The computer-implemented method of claim 14, wherein each vector chunk embedding further includes a reference to the record stored in the record database.

16. The computer-implemented method of claim 13, wherein the modification includes at least one of an addition of a user to the set of users having access to at least a portion of the record, a removal of a user from the set of users having access to at least a portion of the record, a change to a default access level for the record, or a combination thereof.

17. The computer-implemented method of claim 13, further comprising:
receiving, from a computing device associated with a first user, a natural language search query;
performing a similarity search with respect to the natural language search query to retrieve, from the vector database, a set of vector chunk embedding results;
filtering, based on one or more access control policies, the set of vector chunk embedding results to remove vector chunk embeddings that are not associated with a set of users that includes the first user; and
outputting, to a large language model, filtered vector chunk embedding results to generate a response to the natural language search query.

18. The computer-implemented method of claim 17, further comprising:
determining, by referencing an access control data store, at least one set of user groups to which the first user is a member; and
filtering the vector chunk embedding results according to the at least one set of user groups.

19. The computer-implemented method of claim 18, further comprising:
receiving, from an administrator device, a command to create a new user group, remove a user group, add a user to a selected user group, or remove a user from a selected user group; and
modifying the access control data store according to the command.

20. The computer-implemented method of claim 13, wherein one or more non-transitory computer-readable storage media include instructions that, when executed by one or more processors, cause the one or more processors to execute the method.
